(19) United States
(12) Patent Application Publication
(10) Pub. No.: US 2013/0132162 A1
(43) Pub. Date: May 23, 2013

(54) Method and system for enabling collaboration in an enterprise

(71) Applicants: Arindam Banerjee, Kolkata (IN); Debraj Das, Kolkata (IN); Arabinda Nag Chowdhury, Kolkata (IN)

(72) Inventors: Arindam Banerjee, Kolkata (IN); Debraj Das, Kolkata (IN); Arabinda Nag Chowdhury, Kolkata (IN)

(21) Appl. No.: 13/689,793

(22) Filed: Nov. 30, 2012

(51) Int. Cl. G06Q 10/06

(52) U.S. Cl. CPC G06Q 10/0637
USPC 705/7.36

(57) ABSTRACT

The method and system for effective adoption of collaboration within an enterprise is disclosed. The method discloses a Collaboration Adoption Module (CAM) that addresses all goals and needs of the enterprise from collaboration perspective. The CAM provides an integrated framework that performs quantitative and/or qualitative analysis of plurality of parameters. The CAM measures parameters such as collaboration maturity and As-Is collaboration (current state of collaboration) collaboration, identifies collaboration pains, identifies existing and To-Be collaboration (desired collaboration state) patterns, suggests collaboration roadmap in an automated fashion, calculates Total Cost of Ownership (TCO), predicts Return Of Investment (ROI) and ensures usage of best practices in the collaboration space. The CAM provides a generalized framework for collaboration that applies to a wide range of industry segments.

The present application is a non-provisional filed in pursuant to, and claims priority from U.S. Provisional Application No. 61617376, filed on 29 Mar. 2012, the disclosure of which is hereby incorporated by reference herein.

### TECHNICAL FIELD

The embodiments herein relate to processes around collaboration within an enterprise that, if properly implemented, would ensure all-round benefits for the organization.

### BACKGROUND

Collaboration may be defined as a process in which a group or groups of people work together towards achieving common goals, irrespective of locations of the individuals involved in the process. In an Enterprise, factors such as peoples' participation, business and management processes, technology platform(s) and financial support, contribute in achieving effective collaboration. Today's developing technologies provide a plurality of technology platforms for creating a collaboration environment in the enterprise. A collaboration environment enables people within the enterprise to easily connect with each other and share information. Thus, people can effectively and efficiently contribute to enhancing the enterprise performance, resulting in benefits to the business.

However, mere presence of all the necessary technical drivers for collaboration does not ensure optimal collaboration within an enterprise. Collaboration technology and, more importantly, its adoption within the enterprise (organization) are guided by several hard and soft factors, e.g. preparedness, fitness and willingness to share information. In order for an organization to implement collaboration tools and techniques successfully, a guided journey is called for, for marrying the hard with the soft factors. It is crucial to strike a right balance between the hard and the soft factors and at the same time enable all channels of collaboration and detect possibilities of “over-collaboration” in the enterprise, to avoid risks of ineffective collaboration. To ensure that the enterprise gets returns in the expected way, it is important to know if collaboration in the enterprise is productive and constructive. There arises a need to bridge the gap between information technology enablers and business needs. Thus, enterprises require guidelines or a framework to adopt collaboration in the best possible manner and transform its business.

In this space, some existing methods project road maps, but fail to quantify stages of collaboration during road map projection. Some methods describe aspects of behavioral approach in understanding collaboration readiness of the enterprise but fail to measure overall behavioral aspects of an enterprise. Some methods measure ideation effectiveness based on behavioral patterns. Some methods calculate cost of ownership, but are restricted to specific type of industry segment.

### BRIEF DESCRIPTION OF THE FIGURES

The embodiments herein will be better understood from the following detailed description with reference to the drawings, in which:

FIG. 1 illustrates components of Collaboration Adoption Module (CAM), according to the embodiments disclosed herein;

FIG. 2 illustrates overall 11 service lines and 28 service blocks of strategic module (2 service lines and 4 service blocks) and operational module (9 service lines and 24 service blocks), according to the embodiments disclosed herein;

FIG. 3 illustrates an exemplary mapping between the strategic module and the operational module, according to the embodiments disclosed herein; and

FIG. 4 illustrates a computing environment implementing the application, according to embodiments disclosed herein.

### DETAILED DESCRIPTION OF EMBODIMENTS

The embodiments herein and the various features and details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and a system for effective adoption of collaboration within an enterprise. The method provides a Collaboration Adoption Module (CAM) that addresses all goals and needs of the enterprise from the collaboration perspective. Further, CAM comprises set of result driven tools, process documents, best practices and guidelines to ensure collaboration is constructive and productive. CAM provides an integrated framework that performs quantitative and/or qualitative analysis of the plurality of parameters in the collaboration space. CAM defines several collaboration maturity levels and measures parameters such as As-Is collaboration maturity (current state of collaboration), identifies collaboration pains, identifies the existing and To-Be collaboration patterns (for achieving desired collaboration state), suggests collaboration roadmap in an automated fashion, calculates Total Cost of Ownership (TCO) for collaboration, predicts Return Of Investment (ROI) for collaboration and ensures usage of best practices in the collaboration space through a metadata-driven model. CAM guides the enterprises to investigate their business needs, business processes and achieve optimum collaboration that benefits the business. CAM provides a generalized framework for collaboration that is applicable to a wide range of industry segments.

Throughout the description enterprise and organization is used interchangeably.

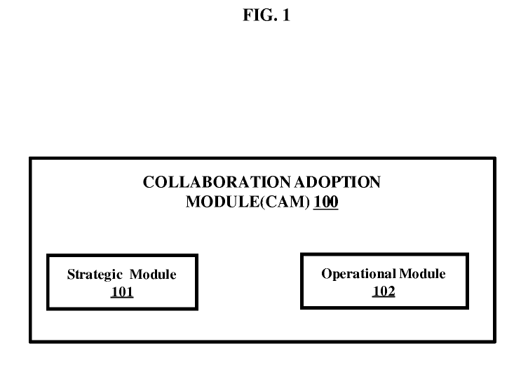

Referring now to the drawings, and more particularly to FIGS. 1 through 4, where similar reference characters denote corresponding features consistently throughout the figures, as are described in the embodiments.

FIG. 1 illustrates components of Collaboration Adoption Module (CAM), according to the embodiments disclosed herein. The figure depicts a Collaboration Adoption Module (CAM) 100, a strategic module 101 and an operational module 102. The CAM 100 provides an integrated framework consisting of a result driven systematic study of the collaboration space in the enterprise. The CAM 100 addresses all goals and needs of the enterprise from a collaboration perspective. The CAM 100 includes tools and techniques to ensure maximum return of investment in the space it addresses. These tools and techniques are provided by the strategic module 101 and the operational module 102. The strategic module 101 obtains desired input parameters from the enterprise and assesses the level of existing collaboration in the enterprise. Further, the strategic module 101 provides guidelines, automated roadmap and collaboration financial impact that enable the enterprise to decide on the strategic objectives and achieve optimum collaboration. The operational module 102 provides a granular level guidance in implementation, architecture and best practices for the implementation of a collaboration platform. The guidance is based on the overall enterprise strategy decided by the strategic module 101. Thus, a close interface between strategic module 101 and operational module 102 guides enterprises to adopt collaboration in the right direction and reach desired goals.

The CAM 100 functions in accordance with COBIT 4.1 standards. The COBIT 4.1 is an IT governance framework and supporting toolset that allows managers to bridge the gap between control requirements, technical issues and business risks.

The CAM 100 addresses the collaboration challenges related to the ubiquity of multiple devices such as Personal Computers(PCs), Laptops, Mobile Devices, tablets, surface 2.0, smart board, Closed Circuit Television (CCTV), sixth sense and the like.

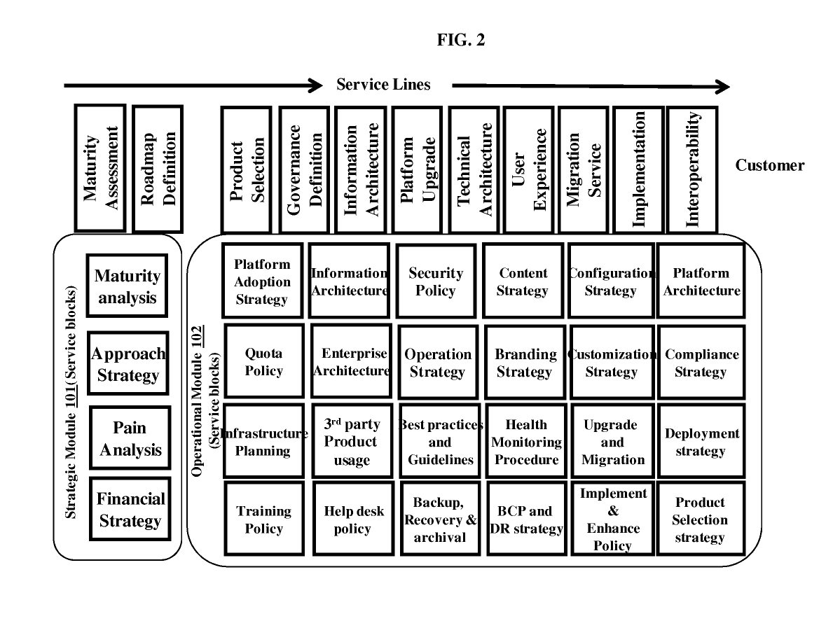

FIG. 2 illustrates service lines and service blocks of the strategic module and the operational module, according to the embodiments disclosed herein. The figure shows CAM 100, depicting various service blocks within the strategic module 101 and operational module 102. In an embodiment the various service lines provided by strategic module 101 include maturity assessment and road map definition and various services lines provided by the operational module 102 include product selection, governance definition, information architecture, platform upgrade, technical architecture, user experience, migration service, implementation, and inter-operability. In an embodiment, artifacts include process documents, guidelines, templates, checklists and tools.

The strategic module 101 is supported with service blocks such as maturity analysis, approach strategy, pain analysis and financial strategy to provide the maturity assessment and the road map definition service lines. The strategic module 101 obtains input parameters such as enterprise profile, enterprise culture/characteristics, drivers, behaviors, pain and cost. The artifacts hold the relevant information (reference data) that is used during maturity analysis, pain analysis, approach strategy and financial strategy decisions of the strategic module 101.

The enterprise profile includes information such as industry segment, enterprise ecosystem, and organization hierarchy and so on. As an example, the industry segment comprises of industry domain, headcounts, revenue, presence in GEOs and tenure in industry. Further, the enterprise culture or characteristics includes cultural value profile, openness profile, collaboration orientation profile, and characteristics profile and so on. As an example, the characteristics profile of the enterprise comprises of characteristics like extroverted or introverted, sensing or intuitive, thinking or feeling and judging and perceiving. Further the behaviors include collaboration activity map, behavior matrix, obstacle matrix, benefit matrix, quality matrix, usage & effectiveness and Willingness Information and so on. Further, the drivers include Business Drivers and IT drivers and so on. As an example, the business drivers comprise Driver Identification, Importance Rating, and Priority Rating. As an example IT drivers comprise Driver Identification, Importance Rating and Priority Rating. Further, pains include risk and issues. As an example, risks comprise count, categorized count and index while issues comprise foreseen issues, unforeseen issues and index. Further, the cost includes Capital Expenditure (CAPEX) cost, SI cost, Operational expenditure (OPEX) cost, administration cost, innovation cost, downtime cost and training cost and so on.

Upon obtaining the input parameters, the strategic module 101 thereafter measures parameters such as readiness, pain impact, state, innovation, maturity, and benefit and so on. These parameters are enablers for determining the As-Is collaboration state of the enterprise. The collaboration readiness of the enterprise is measured using readiness quotient, where, readiness quotient [R_{q}]=fₓ(P, F, W),
Where
P=Preparedness Factor
F=Fitness Factor
W=Willingness Factor

Further, the pain impact on the enterprise is evaluated using root cause analysis (problem analysis). Thereafter, recommendations for the analyzed problems in the business process of the enterprise are put forth. The pain measurement includes measurement of impact on cost, impact on schedule, impact on quality, impact on scope and pain occurrence frequency and so on. The root cause analysis is a cause effect exercise that provides quality management and helps eradicate business risks. The root cause analysis is performed using tools such as Fishbone Analysis. CAM 100 enables automatic generation of fish bone analysis that provides absolute data. The risk assessment mechanism in the pain impact analysis process uses tools such as heat map analysis. The heat map analysis performs comparative (qualitative) risk assessment by identifying and categorizing the risk associated with corresponding steps in the business process of the enterprise. The heat map graphically represents degree of risk associated for corresponding step that may be taken by the enterprise. Thus, heat map enables the organization to foresee those risks that represent opportunities, and those risks that represent potential pitfalls. Thereafter, the CAM 100 recommends steps to be taken by the organization based on the problems (causes) analyzed. The pain analysis provide organizations a clear view of variables to which they may be exposed, whether internal or external, retrospective or forward-looking and recommends necessary changes in the business process.

Further, the collaboration state of the enterprise is measured using

Absolute State Quotient [AS_{q}]=fₓ (R_{q}, P_{q}),

Relative State Quotient [RS_{q}]=fₓ (AS_{q}, Bi_{q}),

### Intensity Index (I)

Where,
R_{q}=Readiness Quotient
P_{q}=Pain Quotient
Bi_{q=}Industry Segment Quotient.
   Intensity Index (I) enables analysis of problems associated with “over-collaboration” Further, the degree of innovation in the enterprise is measured using the innovation quotient. The Innovation Quotient [M]=fₓ (M1, M2, M3, M4, M5),
Where,
M1=Novelty Factor
M2=Quality Factor
M3=Variety Factor
M4=Quantity Factor
M5=Objectivity Factor

Innovation considers factors such as conversion of proposed idea to solution leading to financial benefits, uniqueness of the idea, feasibility of the idea and cost of implementation of the idea and so on.

Further, the maturity of existing collaboration in the enterprise is measured using

Maturity Gradient [M_{G}]=fₓ (As_{q}, RS_{q}, I, M)
Where,
AS_{q}=Absolute State Quotient
RS_{q}=Relative State Quotient
I=Intensity Index
M=Innovation Quotient
   Further, benefit to the enterprises are evaluated using parameters such as impact on cost, impact on revenue and market share, impact on quality and customer satisfaction, impact on GTM (Go To Market) timelines, impact on employee experience and so on.

Upon the measurement of various collaboration parameters described above, the strategic module 101 projects and tracks roadmap, financial impact, pattern, architecture, life cycle and methodology and so on to enable the organization to reach the To-Be state. The road map provides scope definition, blue printing, feasibility and budgetary map to scoped items and roadmap definition on timeline and so on. The roadmap is a tool to help organizations effectively develop strategies and identify and address potential issues beforehand. Further, the financial impact projects and tracks basis, payback period projection and ROI projection. The roadmap describes period (timelines) of actions and key decision points for a plan while the blueprint describes details of the plan. The basis includes cost, benefits and risks. The ROI Projection includes direct and risk adjusted projections and so on. Further, the state module projects and tracks the collaboration architecture which includes shared access, ubiquitous access, coordinating schedule, social engagement, action management, real time joint editing, and automatic discovery service and so on. Further, the collaboration methodology includes types such as message centric methodology, content centric methodology, conversation centric, process centric methodology, and management centric methodology required to be followed by the enterprise to reach the desired state. Further, strategic module 101 projects and tracks the business pattern that includes store and retrieve, real time patterns. The design pattern includes fragment collection, contribution layering, idea exchange, history driven design pattern, template comparison, series flow and mix flow. The execution pattern includes information, communication, task, goal and meta. Further, the life cycle which includes roadmap definition, execution life cycle planning and financial impact realization map is projected and tracked.

The maturity assessment service line uses the various service blocks provided by strategic module 101 to examine enterprise collaboration maturity based on industry segment, culture of the enterprise, characteristics (sensing, intuitive, extrovert, introvert, thinking, feeling, judging, perceiving etc.), behaviors (media usage, responding to obstacles, willingness to collaborate etc.), pains and so on. The maturity assessment process also considers impact of innovation and collaboration intensity (degree of Collaboration with respect to standardized value for its industry segment). The roadmap definition service line uses the various service blocks provided by the strategic module 101 to lay down the roadmap for the enterprise collaboration journey, supported by patterns, methodologies, architecture and life cycle recommendations and financial impact projection.

With the process of obtaining input parameters, evaluating collaboration parameters and projecting and tracking the strategic decisions taken by the enterprise completed, the operational module 102 guides the enterprise to execute the plans in accordance with the strategy recommended by the strategic module 101. The operational module 102 includes service blocks such as platform adoption strategy, quota policy, infrastructure planning, training policy, information architecture, fitment to enterprise architecture, third party product usage policy, help desk policy, security policy, operation strategy, best practices and guidelines, back up, recovery and archival strategy, content strategy, branding strategy, health monitoring procedure, Business Continuity Plan (BCP) and Disaster Recovery (DR) strategy, configuration strategy, customization strategy, upgrade and migration, implementation and enhancement policy, platform architecture, compliance strategy, deployment strategy and product selection strategy. The service blocks of the operational module 102 are interrelated. A predefined set of service blocks work together to support functions of the respective operational service line from the plurality of operational service lines available. The plurality of operational service lines provided include product selection, governance definition, information architecture, platform upgrade, technical architecture, user experience, migration service, implementation, and inter operability and so on. The operational module 102 obtains input parameters such as scope, pain, goals from the strategic module 101. Thereafter the operation module plans parameters such as information architecture governance, application governance, IT governance and design. Further, the operational module 102 executes and tracks implementation of plans, enhancement, migration, support, maintenance and server health monitoring. The various service lines provided by the operational module 102 include the product selection service line that offers a technology agnostic view over enterprise landscape and guides organization to choose the right product for collaboration. The governance definition service line handles all three types of governance stream—information governance, Information Technology (IT) governance and application governance. The information architecture service line builds the information architecture for the collaboration platform within the enterprise. The platform upgrade service line guides the enterprise to upgrade the existing version of the collaboration platform to the latest version. The technical architecture service line handles the architecting and design aspects of the enterprise collaboration platform to fit with the enterprise architecture. The user experience service line deals with user interface and usability aspects of the collaboration platform. The user experience service line enables the enterprise to produce and maintain the user interface and usability of collaboration platform in the most optimum way with support of latest technology. The migration service line deals with the application and content migration from source system to target system. The implementation service line provides end to end guidance to the organization in implementation, enhancement, support and maintenance. The interoperability service line helps the enterprise to exist in a hybrid collaboration environment providing ample integration fronts and strategizes the seamless execution of diverse applications.

The governance definition service line described above enables enterprises to translate strategic objectives to project objectives. The plurality of governance functions is addressed by the governance definition service line, which, include information governance, Information Technology (IT) governance and application governance. The information architecture governance governs taxonomy, folksonomy, site creation rules, indexing, metadata management, user management, content strategy, branding strategy and customization strategy. Further, the IT governance governs hardware, platforms, hosting, security, platform adoption, backup/disaster recovery/availability modules, operation strategy, help desk policy and so on. The IT governance block also governs server management, SLA (service-level agreement) management, quota policy, infrastructure planning and health monitoring procedure. The platform block governs configuration strategy and platform architecture. The security block governs security policy and compliance strategy. The platform adoption governs platform adoption strategy and product selection strategy. The backup/disaster recovery/availability comprises back up (recovery and archival) strategy, Business Continuity Plan (BCP) and disaster recovery (DR) strategy. Further, the application governance block governs functions such as adoption, upgrade, migration, ADM (Application Development and Maintenance), third-party product usage policy, deployment strategy and training policy and so on. Further, the adoption block addresses user interaction, alignment with business, personalization policies, branding, customization tools, best practices and guidelines. The upgrade block addresses upgrade and migration techniques. Further, the ADM block addresses source code control, collaborative development, deployment, implementation and enhancement and the like.

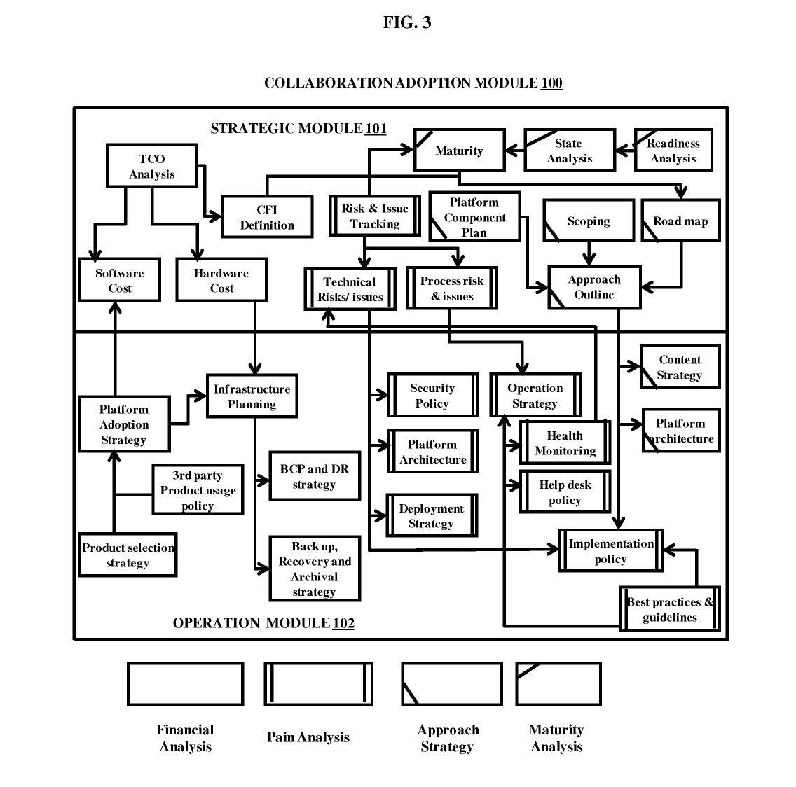

FIG. 3 illustrates an exemplary mapping between the strategic module and the operational module, according to the embodiments disclosed herein. The figure depicts CAM 100 comprising strategic module 101, operational module 102. The figure shows multiple sub blocks within the service blocks of strategic module 101. The strategic module service blocks include financial analysis, pain analysis, approach strategy, maturity analysis. The financial analysis service block includes multiple supporting sub blocks that perform predefined functions. The Total cost of ownership (TCO) sub block calculates TCO of the enterprise. Further, the TCO analysis is used to compute software cost and hardware cost. TCO analysis enables the enterprise to takes into account total cost (from purchase to disposal) rather than looking solely to the purchase cost of a collaboration product. The TCO analysis tool adds other costs to the initial purchase price of a collaboration product. These other costs include costs expected to be incurred during the life of the product such as service, repair, and insurance. The TCO Analysis contributes to the Collaboration Financial Impact (CFI) definition which is as follows.

Collaboration Financial Impact [CFI]=fₓ (C, B, R),
Where,
C=Total Cost of Ownership
B=Benefits produced/experienced
R=Risk Factors
   The CFI enables the organization to know the extent of financial impact of collaboration on the business. Thereafter, ROI is estimated using the CFI. The ROI estimation enables the enterprise to foresee whether success achieved would be in accordance with its expectations. The financial analysis sub block of the strategic module 101 map with the operational module service blocks which include platform adoption strategy, infrastructure planning, third-party product usage policy, backup, recovery, archival strategy and BCP-DR (business continuity and disaster recovery) strategy. Further, BCP synthesizes hard and soft assets to provide effective prevention and recovery for the organization, whilst maintaining competitive advantage and value system integrity. The business continuity plan is the roadmap for continuing operations under adverse conditions (i.e. interruption from natural or man-made hazards). The BCP is an ongoing state or methodology governing how business is conducted. The Disaster recovery (DR) addresses the process, policies and procedures related to preparing the enterprise for recovery or continuation of technology infrastructure, critical to an organization after a natural or human-induced disasters.

The pain analysis service block of the strategic module 101 includes risk and issue tracking that addresses technical risks/issues and process risks/issues. The technical risks/issues and the process risks/issues are mapped with multiple service blocks of the operational module 102. The operational module 102 service blocks mapped to pain analysis sub blocks of strategic module 101 include security policy, platform architecture, deployment strategy, operation strategy, health monitoring, help desk policy, implementation policy and best practices-guidelines and so on.

Further, the approach strategy of strategic module 101 includes sub blocks such as collaboration platform component implementation plan, scoping, road map which decide the enterprise approach outline. The approach outline further drives the content strategy, platform architecture and implementation policy of operational module 102.

Further, the maturity analysis service block of strategic module 101 is supported by sub blocks such as readiness analysis, state analysis and maturity.

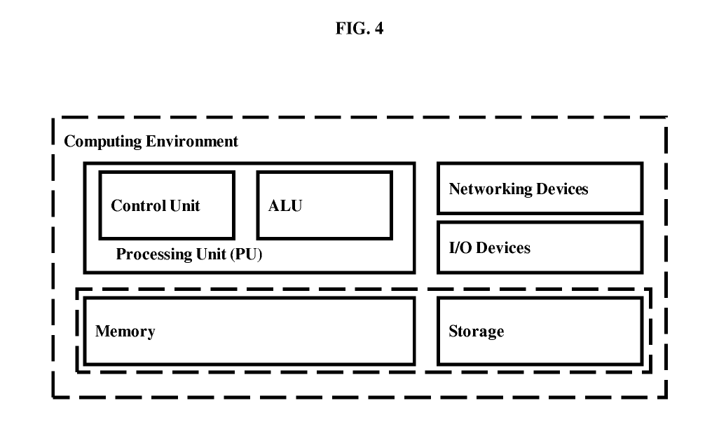

FIG. 4 illustrates a computing environment implementing the application, according to embodiments disclosed herein. As depicted, the computing environment comprises at least one processing unit that is equipped with a control unit and an Arithmetic Logic Unit (ALU), a memory, a storage unit, plurality of networking devices, and a plurality Input output (I/O) devices. The processing unit is responsible for processing the instructions of the algorithm. The processing unit receives commands from the control unit in order to perform its processing. Further, any logical and arithmetic operations involved in the execution of the instructions are computed with the help of the ALU.

The overall computing environment can be composed of multiple homogeneous and/or heterogeneous cores, multiple CPUs of different kinds, special media and other accelerators. The processing unit is responsible for processing the instructions of the algorithm. The processing unit receives commands from the control unit in order to perform its processing. Further, any logical and arithmetic operations involved in the execution of the instructions are computed with the help of the ALU. Further, the plurality of process units may be located on a single chip or over multiple chips.

The algorithm comprising instructions and codes required for the implementation are stored in either the memory unit or the storage or both. At the time of execution, the instructions may be fetched from the corresponding memory and/or storage, and executed by the processing unit.

In case of any hardware implementations various networking devices or external I/O devices may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 and 4 include blocks which can be at least one of a hardware device, or a combination of hardware device and software module.

The embodiments disclosed herein can be implemented through at least one software program running on at least one hardware device and performing network management functions to control the network elements. The network elements shown in FIGS. 1, 2, 3 and 4 include blocks which can be at least one of a hardware device, or a combination of hardware device and software module.

The embodiments disclosed herein specifies a system for Collaboration Adoption Module (CAM) 100. The mechanism allows collaboration using tools, guidelines, checklists, process documents, templates on a common collaboration program. Therefore, it is understood that the scope of the protection is extended to such a program and in addition to a computer readable means containing program code required for implementation of one or more steps of the method, when the program runs on a server or mobile device or any suitable programmable device.

The embodiments disclosed herein may be used as a tool which keeps audit logs for user activities and errors are logged into a Log file and Event Logger based on need, wherein the tool is intuitive to provide helps in relevant sections. Further, this tool has the intelligence of guiding the user along journey from service line to service blocks and then to relevant areas of action. Also, the embodiments disclosed herein enable operations on configurable metadata model causing change in parameters and data with changing market scenarios.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for supporting optimal collaboration in an enterprise, wherein said method comprises:
obtaining at least one set of input parameters of said enterprise;
measuring at least one set of collaboration parameters based on said at least one set input parameters to determine current state of collaboration;
providing collaboration strategy by analyzing said measured at least one collaboration parameter; and
achieving said optimal collaboration by implementing said collaboration strategy in said enterprise.

2. The method as in claim 1, wherein said at least one set of input parameters comprises profile, culture, characteristics, drivers, behaviors, pain, idea and cost.

3. The method as in claim 1, wherein said at least one set of collaboration parameters comprises readiness, pain impact, state, innovation, maturity and benefit.

4. The method as in claim 1, wherein said strategy comprises at least one of:
maturity assessment and roadmap definition.

5. A system for supporting optimal collaboration in an enterprise, wherein said system comprises collaboration adoption module (CAM), wherein said CAM comprises strategic module, operation module, further said system comprises:
an integrated circuit further comprising at least one processor;
at least one memory having a computer program code within said circuit;
said at least one memory and said computer program code configured to with said at least one processor cause said CAM to:
obtain at least one set of input parameters of said enterprise;
measure at least one set of collaboration parameters based on said at least one input parameter by said strategic module;
provide collaboration strategy by analyzing said measured at least one collaboration parameter using said strategic module; and
achieve said optimal collaboration by implementing said collaboration strategy in said enterprise using said operation module.

6. The system as in claim 5, wherein said at least one set of collaboration parameters comprises readiness, pain impact, state, innovation, maturity and benefit.

7. The system as in claim 5, wherein said strategic module is configured to:
measure said readiness by calculating readiness quotient,
measure pain impact by at least one of: pain measurement, heat map analysis, fishbone analysis,
measure state by calculating at least one of: absolute state quotient, relative state quotient;
measure innovation by calculating innovation quotient;
measure maturity by calculating maturity gradient; and
measure benefit by calculating at least one of: impact on cost, impact on revenue and market share, impact on quality and customer satisfaction, impact on GTM condition and impact on employee experience.

8. The system as in claim 5, wherein said strategy module is configured to perform maturity assessment and roadmap definition.

9. The system as in claim 5, wherein said strategic module is configured to calculate Total Cost of Ownership (TCO) and Returns on Investment (ROI) based on said TCO.

10. A computer program product for supporting optimal collaboration in an enterprise wherein said program comprising:
an integrated circuit further comprising at least one processor;
at least one memory having a computer program code within said circuit;
said at least one memory and said computer program code configured to, with said at least one processor cause the product to:
obtain at least one input parameter of said enterprise;
measure at least one collaboration parameter based on said at least one input parameter;
provide collaboration strategy by analyzing said measured at least one collaboration parameter; and
achieve said optimal collaboration by implementing said collaboration strategy in said enterprise.
